(19) United States
(12) Patent Application Publication
(10) Pub. No.: US 2022/0003980 A1
(43) Pub. Date: Jan. 6, 2022

(54) LIGHT-SHEET IMAGING

(71) Applicant: University Court of the University of St Andrews, St Andrews (GB)

(72) Inventors: Kishan Dholakia, Fife (GB); Mingzhou Chen, Fife (GB); Adria Escobet-Montalban, Fife (GB)

(73) Assignee: University Court of the University of St Andrews, St Andrews (GB)

(21) Appl. No.: 17/280,112

(22) PCT Filed: Sep. 24, 2019
(86) PCT No.: PCT/GB2019/052684

§ 371 Date: Mar. 25, 2021

(30) Foreign Application Priority Data
Oct. 11, 2018 (GB) 1816607.4

(51) Int. Cl. G02B 21/06; G02B 21/36

(52) U.S. Cl. CPC G02B 21/06; G02B 21/367

(57) ABSTRACT

A method for use in light-sheet imaging of an object through a scattering medium comprises illuminating the object through the scattering medium with incident electromagnetic radiation propagating along an illumination axis so that the incident electromagnetic radiation interacts with the object to cause the object to generate and emit electromagnetic radiation. The incident electromagnetic radiation is formed by spectrally dispersing initial electromagnetic radiation in a direction transverse to the illumination axis so as to form spectrally dispersed electromagnetic radiation and by spatially focusing the spectrally dispersed electromagnetic radiation through the scattering medium to the object. The method comprises forming an image of at least a portion of the emitted electromagnetic radiation propagating along a detection axis, wherein the detection axis and the illumination axis are non-collinear, and sensing the formed image. The object and/or the scattering medium may comprise biological material, for example human or animal tissue. The method may be used for light-sheet imaging in vivo or in vitro. A system for use in light-sheet imaging of an object through a scattering medium is configured to perform the method.

### FIELD

The present disclosure relates to a method and a system for use in light-sheet imaging of an object through a scattering medium and, in particular though not exclusively, for light-sheet imaging of an object in the form of a sub-surface region of a sample through a scattering medium in the form of a scattering surface region of the same sample. The object and/or the scattering medium may comprise biological material, for example human or animal tissue. The method and system may be used for light-sheet imaging in vivo or in vitro.

### BACKGROUND

Light-sheet microscopy (LSM) typically exploits perpendicular illumination and detection pathways in combination with planar illumination to provide rapid, high contrast, optically sectioned volumes of biological specimens. Due to its high acquisition rates and ability to achieve high contrast in optically thick tissues, LSM is not only revolutionising developmental biology and neuroscience, but can also be used at the single cell level to give extremely fast volumetric imaging of volumes up 1 mm³ at several volumes per second. LSM is also advantageous because it enables relatively high imaging speeds and relatively low photo-damage.

To achieve good optical sectioning (i.e. good axial resolution) the light-sheet must be focused down which, due to fundamental beam divergence, limits the field-of-view over which the light-sheet remains thin. Consequently, it is known to use propagation-invariant optical modes, notably Airy beams, Bessel beams, and optical lattices, to overcome the divergence of the light-sheet and achieve high axial resolution over large volumes. These beams also exhibit a number of unique properties which can be exploited to improve image quality such as self-healing and attenuation-compensation.

One of the major challenges for light-sheet imaging is depth penetration. For example, it is known to use the self-healing properties of Airy and Bessel beams for light-sheet imaging to increase the depth penetration achieved. Alternatively, it is known to use aberration correction or complex correction at a single point to increase the depth penetration achieved. However, such known methods may not be suitable for light-sheet microscopy in highly scattering tissues.

### SUMMARY

It should be understood that any one or more of the features of any of the following aspects or embodiments may be combined with any one or more of the features of any of the other aspects or embodiments.

According to at least one aspect or to at least one embodiment there is provided a method for use in light-sheet imaging of an object through a scattering medium, the method comprising:

illuminating the object through the scattering medium with incident electromagnetic radiation propagating along an illumination axis so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination axis so as to form spectrally dispersed electromagnetic radiation and by spatially focusing the spectrally dispersed electromagnetic radiation through the scattering medium to the object;

forming an image of at least a portion of the emitted electromagnetic radiation propagating along a detection axis, wherein the detection axis and the illumination axis are non-collinear; and

sensing the formed image.

The detection axis and the illumination axis may be non-parallel.

The detection axis and the illumination axis may be orthogonal.

The method may comprise:

spectrally dispersing the initial electromagnetic radiation in the direction transverse to the illumination axis so as to form the spectrally dispersed electromagnetic radiation; and

spatially focusing the spectrally dispersed electromagnetic radiation through the scattering medium to form the incident electromagnetic radiation in the object.

One of skill in the art will understand that the incident electromagnetic radiation is formed by spatio-temporal focusing. Such a method may enable light-sheet imaging of an object through a scattering medium over a greater field of view when compared with known light-sheet imaging methods. Additionally or alternatively, such a method may enable light-sheet imaging of an object through a scattering medium with enhanced axial resolution.

The incident electromagnetic radiation may be provided as a line of incident electromagnetic radiation in the object.

The line of incident electromagnetic radiation may extend in the object in a direction which is orthogonal to the illumination axis.

The method may comprise providing the initial electromagnetic radiation as a line of initial electromagnetic radiation.

The method may comprise spatially focusing the spectrally dispersed electromagnetic radiation through the scattering medium to the object so as to form the line of incident electromagnetic radiation in the object.

The method may comprise moving the line of incident electromagnetic radiation relative to the object and the scattering medium.

The method may comprise moving the line of incident electromagnetic radiation relative to the object and the scattering medium along the illumination axis to thereby effectively illuminate a single plane through the object. The line of incident electromagnetic radiation may extend in the object in a direction which is parallel to the illumination axis.

The method may comprise moving the line of incident electromagnetic radiation relative to the object and the scattering medium.

The method may comprise moving the line of incident electromagnetic radiation relative to the object and the scattering medium in a direction transverse to the illumination axis to thereby effectively illuminate a single plane through the object.

The method may comprise moving the object and the scattering medium together relative to the incident electromagnetic radiation.

According to at least one aspect or to at least one embodiment there is provided a system for use in light-sheet imaging of an object through a scattering medium, the system comprising:

an illumination arrangement for illuminating the object through the scattering medium with incident electromagnetic radiation propagating along an illumination axis so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination axis so as to form spectrally dispersed electromagnetic radiation and by spatially focusing the spectrally dispersed electromagnetic radiation through the scattering medium to the object; and

a detection arrangement comprising:
an imaging arrangement for forming an image of at least a portion of the emitted electromagnetic radiation propagating along a detection axis, wherein the detection axis and the illumination axis are non-collinear; and
an image sensor for sensing the formed image.

The detection axis and the illumination axis may be non-parallel.

The detection axis and the illumination axis may be orthogonal. The illumination arrangement may comprise:

a spectrally dispersive element such as a diffraction grating for spectrally dispersing the initial electromagnetic radiation in the direction transverse to the illumination axis so as to form the spectrally dispersed electromagnetic radiation; and

a spatial focusing arrangement located after the spectrally dispersive element for spatially focusing the spectrally dispersed electromagnetic radiation through the scattering medium to form the incident electromagnetic radiation in the object.

One of skill in art will understand that the incident electromagnetic radiation is formed by spatio-temporal focusing. Such a system may enable light-sheet imaging of an object through a scattering medium over a greater field of view when compared with known light-sheet imaging systems. Additionally or alternatively, such a system may enable light-sheet imaging of an object through a scattering medium with enhanced axial resolution.

The spatial focusing arrangement may comprise an illumination objective lens for spatially focusing the spectrally dispersed electromagnetic radiation through the scattering medium to form the incident electromagnetic radiation in the object. The imaging arrangement may comprise a detection objective lens for collecting at least a portion of the emitted electromagnetic radiation.

The system may comprise a single objective lens for spatially focusing the spectrally dispersed electromagnetic radiation through the scattering medium to form the incident electromagnetic radiation in the object and for collecting at least a portion of the emitted electromagnetic radiation.

The imaging arrangement may comprise a mirror such as a dichroic mirror for reflecting the emitted electromagnetic radiation collected by the single objective lens.

The spatial focusing arrangement may comprise an illumination optical fibre for spatially focusing the spectrally dispersed electromagnetic radiation through the scattering medium to form the incident electromagnetic radiation in the object.

The imaging arrangement may comprise a detection optical fibre for collecting at least a portion of the emitted electromagnetic radiation.

The system may comprise a single optical fibre for spatially focusing the spectrally dispersed electromagnetic radiation through the scattering medium to form the incident electromagnetic radiation in the object and for collecting at least a portion of the emitted electromagnetic radiation.

The imaging arrangement may comprise a mirror such as a dichroic mirror for reflecting the emitted electromagnetic radiation collected by the single optical fibre.

The incident electromagnetic radiation may be provided as a line of incident electromagnetic radiation in the object.

The line of incident electromagnetic radiation may extend in the object in a direction which is orthogonal to the illumination axis.

The system may comprise a cylindrical focusing element such as a cylindrical lens located before the spectrally dispersive element for converting a beam of initial electromagnetic radiation into a focused line of initial electromagnetic radiation at the spectrally dispersive element.

The spatial focusing arrangement may be configured to spatially focus the spectrally dispersed electromagnetic radiation to the object though the scattering medium so as to form the line of incident electromagnetic radiation in the object.

The spatial focusing arrangement may comprise a cylindrical focusing element such as a cylindrical lens.

The spatial focusing arrangement may comprise a tuneable focusing element such as a tuneable focusing lens for moving the line of incident electromagnetic radiation relative to the object and the scattering medium, for example along the illumination axis.

Such a tuneable focusing element may be configured to move the line of incident electromagnetic radiation across the object along the illumination axis to thereby effectively illuminate a single plane through the object.

The tuneable focusing element may be configured to move the line of incident electromagnetic radiation across the object along the illumination axis over a time period which is less than an integrating time of the image sensor.

One of skill in the art will understand that when the detection axis and the illumination axis are non-collinear but not orthogonal, the distance between the illuminated plane and the imaging arrangement of the detection arrangement may vary so that at least part of the light-sheet image may be defocused. Thus, when the detection axis and the illumination axis are non-collinear but not orthogonal, the sensed light-sheet image may be post-processed to compensate for the defocus along the detection axis of different points in the illuminated plane.

The system may comprise a translation stage for moving the object and the scattering medium together relative to the incident electromagnetic radiation.

The system may comprise a translation stage for moving the object and the scattering medium together relative to the incident electromagnetic radiation along the illumination axis. Moving the object and the scattering medium together relative to the line of incident electromagnetic radiation may cause the object to move relative to the line of incident electromagnetic radiation along the illumination axis so as to effectively illuminate a single plane through the object.

One of skill in the art will understand that when the detection axis and the illumination axis are non-collinear but not orthogonal, the distance between the illuminated plane and the imaging arrangement of the detection arrangement may vary so that at least part of the light-sheet image may be defocused. Thus, when the detection axis and the illumination axis are non-collinear but not orthogonal, the sensed light-sheet image may be post-processed to compensate for the defocus along the detection axis of different points in the illuminated plane.

The system may comprise a translation stage for moving the object and the scattering medium together relative to the incident electromagnetic radiation in a direction which is transverse to the illumination axis for volumetric imaging of the object.

The line of incident electromagnetic radiation may extend in a direction which is parallel to the illumination axis.

The spatial focusing arrangement may comprise a prism such as a roof-prism located after the spectrally dispersive element for forming the line of incident electromagnetic radiation.

The spatial focusing arrangement may comprise a cylindrical collimating arrangement located between the spectrally dispersive element and the roof prism for cylindrically collimating the beam of spectrally dispersed electromagnetic radiation before the beam of spectrally dispersed electromagnetic radiation is incident on the roof prism.

Use of a prism such as a roof prism may create a propagation invariant line of incident electromagnetic radiation which extends in a direction which is parallel to the illumination axis. Such a system may employ spatio-temporal focusing to extend the field of view and/or enhance the axial resolution of a light sheet image compared with a system which uses a light-sheet formed from a Bessel beam without spatio-temporal focusing.

The cylindrical collimating arrangement may comprise a further dispersive element such as a further diffraction grating.

The cylindrical collimating arrangement may comprise a cylindrical collimating lens or a cylindrical collimating mirror.

The system may comprise a translation stage for moving the object and the scattering medium together relative to the incident electromagnetic radiation in a direction which is transverse to the illumination axis so as to effectively illuminate a single plane through the object.

One of skill in the art will understand that when the detection axis and the illumination axis are non-collinear but not orthogonal, the distance between the illuminated plane and the imaging arrangement of the detection arrangement may vary so that at least part of the light-sheet image may be defocused. Thus, when the detection axis and the illumination axis are non-collinear but not orthogonal, the sensed light-sheet image may be post-processed to compensate for the defocus along the detection axis of different points in the illuminated plane.

The system may comprise a translation stage for moving the object and the scattering medium together relative to the incident electromagnetic radiation in a direction which is transverse to the illumination axis for volumetric imaging of the object.

The illumination arrangement may comprise a source of electromagnetic radiation.

The source of electromagnetic radiation may comprise a source of coherent electromagnetic radiation.

The source of electromagnetic radiation may be tuneable.

The source of electromagnetic radiation may comprise a laser.

The source of electromagnetic radiation may comprise an optical parametric oscillator (OPO).

The source of electromagnetic radiation may be configured to generate pulses of electromagnetic radiation such as ultrashort pulses of electromagnetic radiation.

The use of pulsed electromagnetic radiation may provide the initial electromagnetic radiation with a predetermined spectral bandwidth which may facilitate spectral dispersion of the initial electromagnetic radiation.

The pulses of electromagnetic radiation may be unchirped. The pulses of electromagnetic radiation may be transform-limited.

The pulses of electromagnetic radiation may be chirped.

The system may be configured for microscopy.

The system may be configured for use with a microscope.

The system may comprise a microscope.

The object may be formed separately from the scattering medium.

The object may comprise a sub-surface region of a sample and the scattering medium may comprise a scattering surface region of the same sample. The sub-surface region of the sample may comprise an extended region of the sample, for example a 2D region of the sample such as a plane, or a 3D region of the sample.

The scattering medium may be time-varying. For example, the scattering medium may comprise, or be, a turbulent fluid.

The scattering medium may be fluorescent.

The object may be a non-scattering object.

The object may be a scattering object.

The object may be time-varying. For example, the object may comprise, or be, a turbulent fluid.

The object may be fluorescent.

The object may comprise one or more exogenous fluorophores such as a green fluorescent protein (GFP) or a red fluorescent protein (RFP).

The object may comprise one or more endogenous fluorophores such as NADH and/or flavins.

The object may scatter the incident electromagnetic radiation and/or the emitted electromagnetic radiation generated in the object.

The object and/or the scattering medium may comprise biological material. The object and/or the scattering medium may comprise human or animal tissue. The object and/or the scattering medium may comprise at least one of: one or more cells, a colloid and an organism. The object and/or the scattering medium may be alive or dead.

The incident electromagnetic radiation and the emitted electromagnetic radiation may have different spectra and/or one or more different wavelengths.

The incident electromagnetic radiation may comprise light, for example infrared, visible or UV light.

The emitted electromagnetic radiation may comprise light, for example infrared, visible or UV light.

The emitted electromagnetic radiation may comprise THz radiation.

The emitted electromagnetic radiation may comprise fluorescence generated by the object as a result of excitation of the object by the incident electromagnetic radiation.

The incident electromagnetic radiation may be configured for multi-photon excitation of the object. For example, the incident electromagnetic radiation may include an appropriate wavelength or range of wavelengths for multi-photon excitation of the object.

The incident electromagnetic radiation may be configured for two-photon excitation of the object. For example, the incident electromagnetic radiation may include an appropriate wavelength or range of wavelengths for two-photon excitation of the object. The incident electromagnetic radiation may include a wavelength in the range of 680 nm to 1080 nm, for example a wavelength in the range 700 nm to 950 nm.

The incident electromagnetic radiation may be configured for three-photon excitation of the object. For example, the incident electromagnetic radiation may include an appropriate wavelength or range of wavelengths for three-photon excitation of object. The incident electromagnetic radiation may include a wavelength in the range of 1,300 nm to 1,700 nm.

The emitted electromagnetic radiation may be generated by the object as a result of a non-linear optical interaction between the incident electromagnetic radiation and the object.

The emitted electromagnetic radiation may comprise a harmonic of the incident electromagnetic radiation, such as a second harmonic of the incident electromagnetic radiation or a third harmonic of the incident electromagnetic radiation.

The emitted electromagnetic radiation may be generated by the object as a result of inelastic scattering of the incident electromagnetic radiation in the object.

The emitted electromagnetic radiation may be generated by the object as a result of Raman scattering of the incident electromagnetic radiation in the object.

The emitted electromagnetic radiation may be generated by the object as a result of coherent or stimulated Raman scattering of the incident electromagnetic radiation in the object.

The emitted electromagnetic radiation may be generated by the object as a result of Coherent Anti-Stokes Raman Scattering (CARS) in the object.

The incident electromagnetic radiation may comprise a stream of pulses of electromagnetic radiation.

Each pulse of the incident electromagnetic radiation may have a duration of 1 ps or less, 500 fs or less, 100-200 fs, or 10-100 fs.

The incident electromagnetic radiation may have an average power in the range 100-1,000 mW, 10 mW-100 mW or 1 mW-10 mW.

The line of incident electromagnetic radiation may have an average power density of up to 10 μW/μm² or an average power density of up to 1,000 μW/μm² when accounting for all spectral components of the line of incident electromagnetic radiation.

### BRIEF DESCRIPTION OF THE DRAWINGS

A method and a system for use in imaging an object through a scattering medium will now be described by way of non-limiting example only with reference to the drawings of which:

FIG. 1 shows a light-sheet imaging system;

FIG. 2 shows an alternative illumination arrangement for replacing an illumination arrangement of the light-sheet imaging system of FIG. 1; and

FIG. 3 shows an alternative light-sheet imaging system.

### DETAILED DESCRIPTION OF THE DRAWINGS

One of skill in the art will understand that one or more of the features of the embodiments described below with reference to the drawings may produce effects or provide advantages when used in isolation from one or more of the other features of the embodiments and that different combinations of the features are possible other than the specific combinations of the features of the embodiments described below.

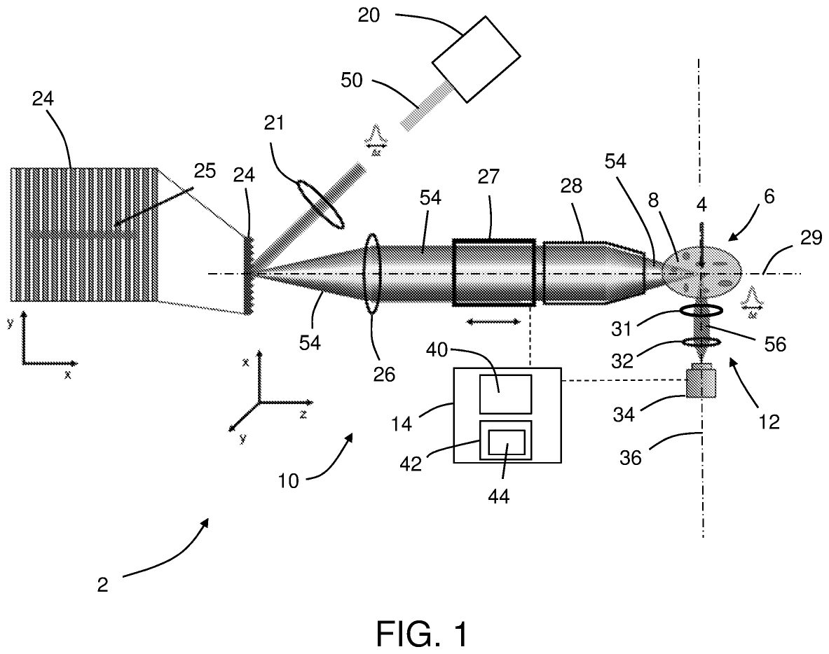

Referring initially to FIG. 1 there is shown a light-sheet imaging system in the form of a multi-photon excitation fluorescence light-sheet imaging system generally designated 2 for use in light-sheet imaging a fluorescent object in the form of a fluorescent sub-surface region 4 of a sample, generally designated 6, through a scattering medium in the form of a scattering surface region 8 of the sample 6.

The light-sheet imaging system 2 includes an illumination arrangement generally designated 10 for illuminating the fluorescent sub-surface region 4 of the sample 6 with incident electromagnetic radiation, and a detection arrangement generally designated 12 for sensing an image of the corresponding electromagnetic radiation in the form of the corresponding fluorescence generated in and emitted from the fluorescent sub-surface region 4 of the sample 6. The light-sheet imaging system 2 further includes a processing resource generally designated 14.

The illumination arrangement 10 includes a source of electromagnetic radiation in the form of a pulsed laser 20, a cylindrical focusing element in the form of a cylindrical lens 21, a dispersive element in the form of a diffraction grating 24, a collimating lens 26, a tuneable focusing lens 27, and an illumination objective lens 28. The collimating lens 26, the tuneable focusing lens 27, and the illumination objective lens 28 are arranged co-axially along an illumination axis 29 extending in the z-direction. As will be appreciated by one of ordinary skill in the art, FIG. 1 shows two views of the diffraction grating 24: a first “edge-on” view showing diffraction grating 24 “in situ” receiving light from the pulsed laser 20 and directing the received light towards the collimating lens 26; and a second en face view of the diffraction grating 24 showing the grooves of the diffraction grating 24 extending in the y-direction and a focused line 25 of initial electromagnetic radiation extending on the diffraction grating 24 in the x-direction orthogonal to the grooves of the diffraction grating 24.

The detection arrangement 12 includes a detection objective lens 31, a focusing lens 32, and an image sensor 34. The detection objective lens 31, the focusing lens 32 and the image sensor 34 are arranged co-axially along a detection axis 36 which is orthogonal to the illumination axis 29. It should be understood that, although the detection axis 36 is shown in FIG. 1 aligned in the x-direction, this is for clarity only and, in reality, the detection axis 36 is actually aligned along the y-direction.

The processing resource 14 includes a processor 40 and a memory 42. The memory 42 stores a computer program 44. The processing resource 14 is configured for communication with the tuneable focusing lens 27 and the image sensor 34.

In use, the pulsed laser 20 generates initial electromagnetic radiation in the form of a beam 50 of ultrashort laser pulses, for example unchirped approximately transform-limited laser pulses having a duration Δt of 140 fs, at a wavelength of 800 nm and a repetition rate of 80 MHz. The cylindrical lens 21 focuses the beam 50 in the y-direction so as to form the focused line 25 of initial electromagnetic radiation on the diffraction grating 24. The diffraction grating 24 spectrally disperses the beam 50 so as to form spectrally dispersed electromagnetic radiation 54 which propagates along the illumination axis 29. The collimating lens 26 collimates the spectrally dispersed electromagnetic radiation 54 and the tuneable focusing lens 27 and the illumination objective lens 28 focus the collimated spectrally dispersed electromagnetic radiation 54 through the scattering surface region 8 of the sample 6 to form a line of incident electromagnetic radiation in the fluorescent sub-surface region 4 of the sample 6. As will be appreciated by one of ordinary skill in the art, the combination of the collimating lens 26, the tuneable focusing lens 27 and the illumination objective lens 28 images the focused line 25 of initial electromagnetic radiation on the diffraction grating 24 to the line of incident electromagnetic radiation in the fluorescent sub-surface region 4 of the sample 6 such that the line of incident electromagnetic radiation extends in the fluorescent sub-surface region 4 of the sample 6 in the x-direction. One of skill in the art will understand that each point on the line of incident electromagnetic radiation is an image of a corresponding point on the focused line 25 of initial electromagnetic radiation on the diffraction grating 24 and that all of the different wavelengths of the spectrally dispersed electromagnetic radiation 54 are superimposed at each point on the line of incident electromagnetic radiation. From the foregoing description, one of skill in the art will further understand that each point on the line of incident electromagnetic radiation is formed by spatio-temporal focusing.

The line of incident electromagnetic radiation interacts with the fluorescent sub-surface region 4 of the sample 6 to cause the fluorescent sub-surface region 4 of the sample 6 to emit electromagnetic radiation in the form of fluorescence 56. A portion of the fluorescence 56 propagates along the detection axis 36 through the scattering surface region 8 of the sample 6 and is collected by the detection objective lens 31. The focusing lens 32 focuses the collected fluorescence 56 onto the image sensor 34 which senses an image of the collected fluorescence 56. In effect, the detection objective lens 31 and the focusing lens 32 together serve as an imaging arrangement which images a portion of the fluorescence 56 propagating along the detection axis 36 onto the image sensor 34.

When executed by the processor 40, the computer program 44 causes the processing resource 14 to control the tuneable focusing lens 27 and the image sensor 34 so that the tuneable focusing lens 27 sweeps the line of incident electromagnetic radiation through a plurality of z-positions in the fluorescent sub-surface region 4 of the sample 6. The line of incident electromagnetic radiation is swept through the plurality of z-positions over a time period which is much less than an integrating time of the image sensor 34 to thereby effectively illuminate a single x-z plane through the fluorescent sub-surface region 4 of the sample 6 whilst the image sensor 34 senses an image of the collected fluorescence 56 to thereby obtain a light-sheet image of the single illuminated x-z plane through the fluorescent sub-surface region 4 of the sample 6.

One of ordinary skill in the art will understand that the light-sheet imaging system 2 of FIG. 1 may comprise a y-axis translation stage (not shown) for translating the sample 6 in the y-direction relative to the illumination arrangement 10 for volumetric imaging of the fluorescent sub-surface region 4 of the sample 6. The y-axis translation stage (not shown) may be controlled by the processing resource 14. The processing resource 14 may co-ordinate the operations of the tuneable focusing lens 27, the image sensor 34 and the y-axis translation stage (not shown) to produce a volumetric image of the fluorescent sub-surface region 4 of the sample 6.

Additionally or alternatively, one of ordinary skill in the art will understand that the light-sheet imaging system 2 of FIG. 1 may comprise a beam scanning arrangement (not shown) located between the collimating lens 26 and the illumination objective 28, which beam scanning arrangement (not shown) is operable to spatially scan the y-position of the spectrally dispersed radiation 54 relative to the sample 6 and thereby scan the y-position of the line of incident electromagnetic radiation on the fluorescent sub-surface region 4 of the sample 6 for volumetric imaging of the fluorescent sub-surface region 4 of the sample 6. One of ordinary skill in the art will also understand that, when using such a beam scanning arrangement (not shown), the light-sheet imaging system 2 of FIG. 1 may further comprise a further tuneable focusing lens (not shown) between the detection objective 31 and the focusing lens 32, which further tuneable focusing lens (not shown) may be operable to image fluorescence emitted from the y-position of the line of incident electromagnetic radiation on the fluorescent sub-surface region 4 of the sample 6. The beam scanning arrangement (not shown) and the further tuneable focusing lens (not shown) may be controlled by the processing resource 14. The processing resource 14 may co-ordinate the operations of the tuneable focusing lens 27, the beam scanning arrangement (not shown), the further tuneable focusing lens (not shown), and the image sensor 34 to produce a volumetric image of the fluorescent sub-surface region 4 of the sample 6.

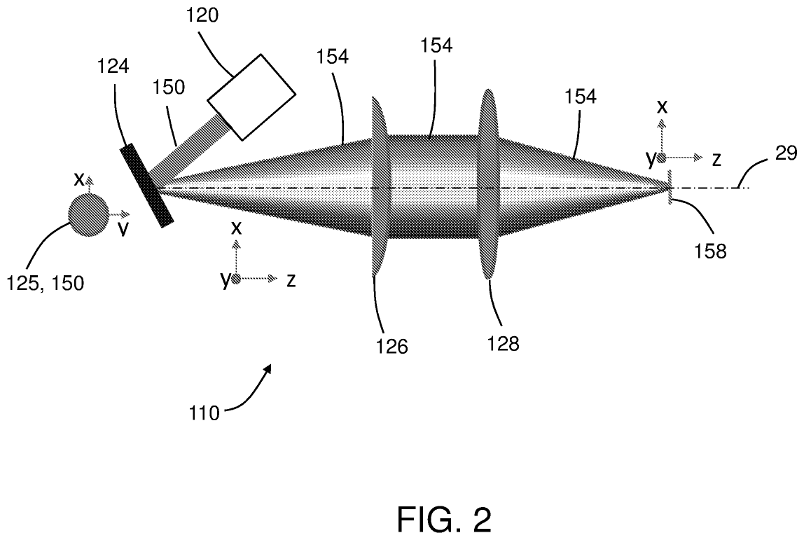

Referring now to FIG. 2 there is shown an alternative illumination arrangement generally designated 110 for replacing the illumination arrangement 10 of the light-sheet imaging system 2 of FIG. 1. The illumination arrangement 110 includes a source of electromagnetic radiation in the form of a pulsed laser 120, a dispersive element in the form of a diffraction grating 124, a cylindrical collimating element in the form of a cylindrical collimating lens 126, and an illumination objective lens 128. The cylindrical collimating lens 126 and the illumination objective lens 128 are arranged co-axially along the illumination axis 29 extending in the z-direction.

In use, the pulsed laser 120 generates initial electromagnetic radiation in the form of the beam 150 of ultrashort laser pulses, for example unchirped approximately transform-limited laser pulses having a duration Δt of 140 fs, at a wavelength of 800 nm and a repetition rate of 80 MHz. The beam 150 has a generally circular cross-section so as to form a circular spot 125 of initial electromagnetic radiation at the surface of the diffraction grating 124. The diffraction grating 124 spectrally disperses the beam 150 so as to form spectrally dispersed electromagnetic radiation 154 which propagates along the illumination axis 29. The cylindrical collimating lens 126 collimates the spectrally dispersed electromagnetic radiation 154 in the x-direction. The illumination objective lens 128 then focuses the collimated spectrally dispersed electromagnetic radiation 154 through the scattering surface region 8 of the sample 6 to form a line of incident electromagnetic radiation 158 in the fluorescent sub-surface region 4 of the sample 6. As will be appreciated by one of ordinary skill in the art, the combination of the cylindrical collimating lens 126 and the illumination objective lens 128 images the circular spot 125 of initial electromagnetic radiation on the diffraction grating 124 to the line of incident electromagnetic radiation 158 in the fluorescent sub-surface region 4 of the sample 6 such that the line of incident electromagnetic radiation 158 extends in the fluorescent sub-surface region 4 of the sample 6 in the x-direction. One of skill in the art will understand that each x-position on the line of incident electromagnetic radiation 158 is an image of the initial electromagnetic radiation 150 incident on the diffraction grating 124 at a corresponding x-position and that all of the different wavelengths of the spectrally dispersed electromagnetic radiation 154 are superimposed at each x-position on the line of incident electromagnetic radiation 158.

The line of incident electromagnetic radiation 158 interacts with the fluorescent sub-surface region 4 of the sample 6 to cause the fluorescent sub-surface region 4 of the sample 6 to emit electromagnetic radiation in the form of fluorescence (like the fluorescence 56 shown in FIG. 1) which is detected using the same detection arrangement 12 described with reference to FIG. 1.

It should be understood that, when using the illumination arrangement 110 of FIG. 2 in place of the illumination arrangement 10 of the light-sheet imaging system 2 of FIG. 1, the light-sheet imaging system 2 may comprise a z-axis translation stage (not shown) for translating the sample 6 in the z-direction relative to the illumination arrangement 110 to thereby obtain a light-sheet image of the fluorescent sub-surface region 4 of the sample 6 in a single x-z plane through the fluorescent sub-surface region 4 of the sample 6 (i.e. in a single x-z plane at a fixed y-position).

It should be further understood that, when using the illumination arrangement 110 of FIG. 2 in place of the illumination arrangement 10 of the light-sheet imaging system 2 of FIG. 1, y-axis scanning between the line of incident electromagnetic radiation 158 and the sample 6 for volumetric imaging of the fluorescent sub-surface region 4 of the sample 6 may be accomplished using any of the y-axis scanning methods described above in relation to FIG. 1.

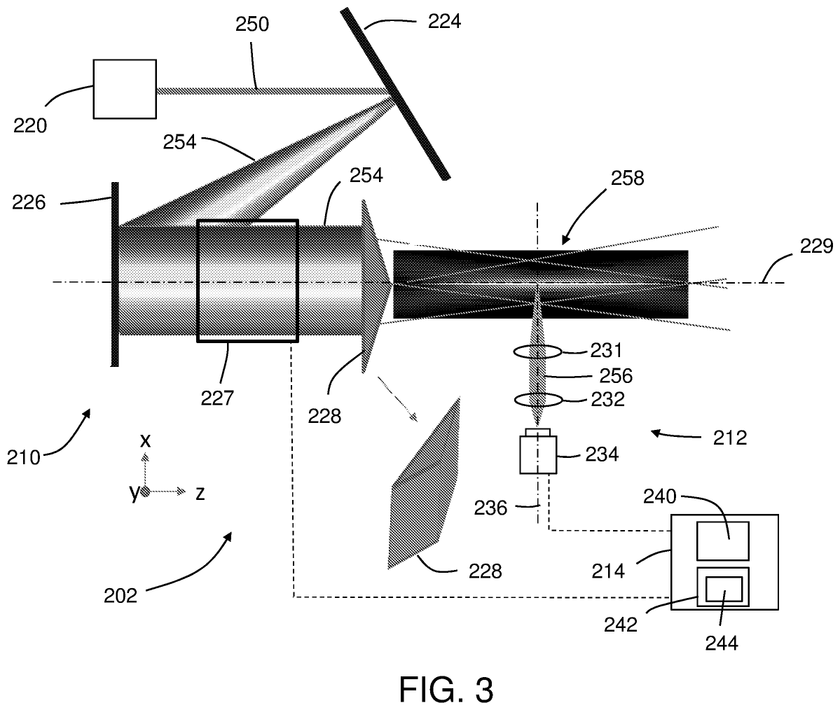

Referring now to FIG. 3, there is shown an alternative light-sheet imaging system in the form of a multi-photon excitation fluorescence light-sheet imaging system generally designated 202 for use in light-sheet imaging a fluorescent object in the form of a fluorescent sub-surface region (not shown) of a sample (not shown) through a scattering medium (not shown) in the form of a scattering surface region of the sample (not shown).

The light-sheet imaging system 202 includes an illumination arrangement generally designated 210 for illuminating the fluorescent sub-surface region of the sample with incident electromagnetic radiation, and a detection arrangement generally designated 212 for sensing an image of the corresponding electromagnetic radiation in the form of the corresponding fluorescence generated in and emitted from the fluorescent sub-surface region of the sample. The light-sheet imaging system 202 further includes a processing resource generally designated 214.

The illumination arrangement includes a source of electromagnetic radiation in the form of a pulsed laser 220, a dispersive element in the form of a first diffraction grating 224, a cylindrical collimating element in the form of a second diffraction grating 226, a beam scanning arrangement 227 comprising at least one Galvanometric mirror (not shown) and one or more focusing elements for scanning a y-position of a beam, and a roof prism 228. The second diffraction grating 226, the beam scanning arrangement 227, and the roof prism 228 are arranged along an illumination axis 229 extending in the z-direction.

The detection arrangement 212 includes a detection objective lens 231, a focusing lens 232 and an image sensor 234. The detection objective lens 231, the focusing lens 232 and the image sensor 234 are arranged co-axially along a detection axis 236 which is orthogonal to the illumination axis 229. In contrast to the light-sheet imaging system 2 of FIG. 1, however, the detection axis 236 of the light-sheet imaging system 202 of FIG. 3 is actually aligned in the x-direction.

The processing resource 214 includes a processor 240 and a memory 242. The memory 242 stores a computer program 244. The processing resource 214 is configured for communication with the beam scanning arrangement 227 and the image sensor 234.

In use, the pulsed laser 220 generates initial electromagnetic radiation in the form of the beam 250 of ultrashort laser pulses, for example laser pulses having a duration Δt of 140 fs, at a wavelength of 800 nm and a repetition rate of 80 MHz. The beam 250 has a generally circular cross-section so as to form a circular spot of initial electromagnetic radiation at a surface of the first diffraction grating 224. The first diffraction grating 224 spectrally disperses the beam 250 so as to form spectrally dispersed electromagnetic radiation 254. The second diffraction grating 226 collimates the spectrally dispersed electromagnetic radiation 254 in the x-direction. As will be described in more detail below, the beam scanning arrangement 227 scans the y-axis position of the collimated spectrally dispersed electromagnetic radiation 254.

For a given y-axis position of the collimated spectrally dispersed electromagnetic radiation 254, the roof prism 228 directs the collimated spectrally dispersed electromagnetic radiation 254 through the scattering surface region of the sample to form a line of incident electromagnetic radiation 258 in the fluorescent sub-surface region of the sample. As will be appreciated by one of ordinary skill in the art, the roof prism 228 images the collimated spectrally dispersed electromagnetic radiation 254 to the line of incident electromagnetic radiation 258 in the fluorescent sub-surface region of the sample such that the line of incident electromagnetic radiation 258 extends in the fluorescent sub-surface region of the sample in the z-direction i.e. parallel to the illumination axis 229.

One of skill in the art will also understand that only a selection of the wavelengths of the spectrally dispersed electromagnetic radiation 254 combine at each z-position of the line of incident electromagnetic radiation 258. For example, the end of the line of incident electromagnetic radiation 258 which is adjacent to the roof prism 228 is formed by the superposition of wavelengths above and below, and close to, a central wavelength of the spectrally dispersed electromagnetic radiation 254, whereas the end of the line of incident electromagnetic radiation 258 which is distal from the roof prism 228 is formed by the superposition of wavelengths above and below, but further from, the central wavelength of the spectrally dispersed electromagnetic radiation 254.

The line of incident electromagnetic radiation 258 interacts with the fluorescent sub-surface region of the sample to cause the fluorescent sub-surface region of the sample to emit electromagnetic radiation in the form of fluorescence 256. A portion of the fluorescence 256 propagates along the detection axis 236 through the scattering surface region of the sample and is collected by the detection objective lens 231. The focusing lens 232 focuses the collected fluorescence 256 onto the image sensor 234 which senses an image of the collected fluorescence 256. In effect, the detection objective lens 231 and the focusing lens 232 together serve as an imaging arrangement which images a portion of the fluorescence 256 propagating along the detection axis 236 onto the image sensor 234. One of skill in the art will understand that the line of incident electromagnetic radiation 258 is shown schematically in FIG. 3 on a scale which is much larger than the scale on which the detection objective lens 231, the focusing lens 232 and the image sensor 234 are shown. Specifically, although FIG. 3 only shows fluorescence 256 emitted from a single point on the line of incident electromagnetic radiation 258, in reality, the detection objective lens 231 and the focusing lens 232 image the fluorescence 256 emitted along the whole length of the line of incident electromagnetic radiation 258.

When executed by the processor 240, the computer program 244 causes the processing resource 214 to control the beam scanning arrangement 227 and the image sensor 234 so that the beam scanning arrangement 227 sweeps the line of incident electromagnetic radiation 258 through a plurality of y-positions in the fluorescent sub-surface region of the sample. The line of incident electromagnetic radiation 258 is swept through the plurality of y-positions over a time period which is much less than an integrating time of the image sensor 234 to thereby effectively illuminate a single y-z plane through the fluorescent sub-surface region of the sample whilst the image sensor 234 senses an image of the collected fluorescence 256 to thereby obtain a light-sheet image of the single illuminated y-z plane through the fluorescent sub-surface region of the sample.

It should be further understood that, the light-sheet imaging system 202 of FIG. 3 includes an x-axis translation stage (not shown) for translating the sample in the x-direction relative to the illumination arrangement 210 for volumetric imaging of the fluorescent sub-surface region of the sample. The x-axis translation stage (not shown) may be controlled by the processing resource 214. The processing resource 214 may co-ordinate the operations of the beam scanning arrangement 227, the image sensor 234 and the x-axis translation stage (not shown) to produce a volumetric image of the fluorescent sub-surface region of the sample.

It will be appreciated by one skilled in the art that various modifications may be made to the foregoing methods and systems without departing from the scope of the present invention as defined by the claims. For example, rather than the second diffraction grating 226 to collimate the spectrally dispersed beam 254 generated by the first diffraction grating 224 in the illumination arrangement 210 shown in FIG. 3, the illumination arrangement 210 may comprise a cylindrical collimating arrangement of any kind located between the first diffraction grating 224 and the beam scanning arrangement 227 for collimating the beam of spectrally dispersed electromagnetic radiation 254. For example, the cylindrical collimating arrangement may comprise a cylindrical collimating lens or a cylindrical collimating mirror.

Rather than comprising one illumination objective lens for spatially focusing the spectrally dispersed electromagnetic radiation through the scattering medium to form the incident electromagnetic radiation in the object and a separate detection objective lens for collecting at least a portion of the emitted electromagnetic radiation, the system may comprise a single objective lens for spatially focusing the spectrally dispersed electromagnetic radiation through the scattering medium to form the incident electromagnetic radiation in the object and for collecting at least a portion of the emitted electromagnetic radiation.

The imaging arrangement may comprise a mirror such as a dichroic mirror for reflecting the emitted electromagnetic radiation collected by the single objective lens.

The system may comprise an illumination optical fibre for spatially focusing the spectrally dispersed electromagnetic radiation through the scattering medium to form the incident electromagnetic radiation in the object.

The imaging arrangement may comprise a detection optical fibre for collecting at least a portion of the emitted electromagnetic radiation.

The system may comprise a single optical fibre for spatially focusing the spectrally dispersed electromagnetic radiation through the scattering medium to form the incident electromagnetic radiation in the object and for collecting at least a portion of the emitted electromagnetic radiation.

The imaging arrangement may comprise a mirror such as a dichroic mirror for reflecting the emitted electromagnetic radiation collected by the single optical fibre.

The source of electromagnetic radiation may be coherent and/or tuneable. The source of electromagnetic radiation may comprise an optical parametric oscillator (OPO).

The pulses of electromagnetic radiation may be chirped.

The light-sheet imaging system may be configured for microscopy.

The light-sheet imaging system may be configured for use with a microscope.

The light-sheet imaging system may comprise a microscope.

Although the object is described above as a sub-surface region of a sample and the scattering medium is described above as a scattering surface region of the same sample, the object may be formed separately from the scattering medium.

The sub-surface region of the sample may comprise an extended region of the sample, for example a 2D region of the sample such as a plane, or a 3D region of the sample.

The scattering medium may be time-varying. For example, the scattering medium may comprise, or be, a turbulent fluid.

The scattering medium may be fluorescent.

The object may be a non-scattering object.

The object may be a scattering object.

The object may be time-varying. For example, the object may comprise, or be, a turbulent fluid.

The object may comprise one or more exogenous fluorophores such as a green fluorescent protein (GFP) or a red fluorescent protein (RFP).

The object may comprise one or more endogenous fluorophores such as NADH and/or flavins.

The object may scatter the incident electromagnetic radiation and/or the emitted electromagnetic radiation generated in the object. The object and/or the scattering medium may comprise biological material. The object and/or the scattering medium may comprise human or animal tissue. The object and/or the scattering medium may comprise at least one of: one or more cells, a colloid and an organism. The object and/or the scattering medium may be alive or dead.

The incident electromagnetic radiation and the emitted electromagnetic radiation may have different spectra and/or one or more different wavelengths.

The incident electromagnetic radiation may comprise light, for example infrared, visible or UV light.

The emitted electromagnetic radiation may comprise light, for example infrared, visible or UV light.

The emitted electromagnetic radiation may comprise THz radiation.

The incident electromagnetic radiation may be configured for two-photon excitation of the object. For example, the incident electromagnetic radiation may include an appropriate wavelength or range of wavelengths for two-photon excitation of the object. The incident electromagnetic radiation may include a wavelength in the range of 680 nm to 1080 nm, for example a wavelength in the range 700 nm to 950 nm.

The incident electromagnetic radiation may be configured for three-photon excitation of the object. For example, the incident electromagnetic radiation may include an appropriate wavelength or range of wavelengths for three-photon excitation of object. The incident electromagnetic radiation may include a wavelength in the range of 1,300 nm to 1,700 nm.

The emitted electromagnetic radiation may be generated by the object as a result of a non-linear optical interaction between the incident electromagnetic radiation and the object.

The emitted electromagnetic radiation may comprise a harmonic of the incident electromagnetic radiation, such as a second harmonic of the incident electromagnetic radiation or a third harmonic of the incident electromagnetic radiation.

The emitted electromagnetic radiation may be generated by the object as a result of inelastic scattering of the incident electromagnetic radiation in the object.

The emitted electromagnetic radiation may be generated by the object as a result of Raman scattering of the incident electromagnetic radiation in the object.

The emitted electromagnetic radiation may be generated by the object as a result of coherent or stimulated Raman scattering of the incident electromagnetic radiation in the object.

The emitted electromagnetic radiation may be generated by the object as a result of Coherent Anti-Stokes Raman Scattering (CARS) in the object.

The incident electromagnetic radiation may comprise a stream of pulses of electromagnetic radiation.

Each pulse of the incident electromagnetic radiation may have a duration of 1 ps or less, 500 fs or less, 100-200 fs, or 10-100 fs.

The incident electromagnetic radiation may have an average power in the range 100-1,000 mW, 10 mW-100 mW or 1 mW-10 mW.

The line of incident electromagnetic radiation may have an average power density of up to 10 μW/μm² or an average power density of up to 1,000 μW/μm² when accounting for all spectral components of the line of incident electromagnetic radiation.

1. A method for use in light-sheet imaging of an object through a scattering medium, the method comprising:
illuminating the object through the scattering medium with incident electromagnetic radiation propagating along an illumination axis so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination axis so as to form spectrally dispersed electromagnetic radiation and by spatially focusing the spectrally dispersed electromagnetic radiation through the scattering medium to the object;
forming an image of at least a portion of the emitted electromagnetic radiation propagating along a detection axis, wherein the detection axis and the illumination axis are non-collinear; and
sensing the formed image.

2. The method of claim 1, comprising:
spectrally dispersing the initial electromagnetic radiation in the direction transverse to the illumination axis so as to form the spectrally dispersed electromagnetic radiation; and
spatially focusing the spectrally dispersed electromagnetic radiation through the scattering medium to form the incident electromagnetic radiation in the object.

3. The method of claim 1, wherein the detection axis and the illumination axis are non-parallel, for example orthogonal.

4. The method of claim 1, wherein the incident electromagnetic radiation is provided as a line of incident electromagnetic radiation in the object.

5. The method of claim 4, wherein the line of incident electromagnetic radiation extends in the object in a direction which is orthogonal to the illumination axis.

6. The method of claim 4, comprising:
providing the initial electromagnetic radiation as a line of initial electromagnetic radiation.

7. The method of claim 4, comprising spatially focusing the spectrally dispersed electromagnetic radiation through the scattering medium to the object so as to form the line of incident electromagnetic radiation in the object.

8. The method of claim 4, wherein the line of incident electromagnetic radiation extends in the object in a direction which is parallel to the illumination axis.

9. The method of claim 1, comprising moving the incident electromagnetic radiation relative to the object and the scattering medium or moving the object and the scattering medium together relative to the incident electromagnetic radiation.

10. (canceled)

11. A system for use in light-sheet imaging of an object through a scattering medium, the system comprising:
an illumination arrangement for illuminating the object through the scattering medium with incident electromagnetic radiation propagating along an illumination axis so that the incident electromagnetic radiation interacts with the object to cause the object to generate and emit electromagnetic radiation, wherein the incident electromagnetic radiation is formed by spectrally dispersing initial electromagnetic radiation in a direction transverse to the illumination axis so as to form spectrally dispersed electromagnetic radiation and by spatially focusing the spectrally dispersed electromagnetic radiation through the scattering medium to the object; and
a detection arrangement comprising:
an imaging arrangement for forming an image of at least a portion of the emitted electromagnetic radiation propagating along a detection axis, wherein the detection axis and the illumination axis are non-collinear; and
an image sensor for sensing the formed image.

12. The system of claim 11, wherein the illumination arrangement comprises:
a spectrally dispersive element such as a diffraction grating for spectrally dispersing the initial electromagnetic radiation in the direction transverse to the illumination axis so as to form the spectrally dispersed electromagnetic radiation; and
a spatial focusing arrangement located after the spectrally dispersive element for spatially focusing the spectrally dispersed electromagnetic radiation through the scattering medium to form the incident electromagnetic radiation in the object.

13. The system of claim 11, wherein the detection axis and the illumination axis are non-parallel, for example orthogonal.

14. The system of claim 11, wherein the incident electromagnetic radiation is provided as a line of incident electromagnetic radiation in the object.

15. The system of claim 14, wherein the line of incident electromagnetic radiation extends in the object in a direction which is orthogonal to the illumination axis.

16. The system of claim 14, comprising a cylindrical focusing element such as a cylindrical lens located before the spectrally dispersive element for converting a beam of initial electromagnetic radiation into a focused line of initial electromagnetic radiation at the spectrally dispersive element.

17. The system of claim 14, wherein the spatial focusing arrangement is configured to spatial focus the spectrally dispersed electromagnetic radiation through the scattering medium so as to form the line of incident electromagnetic radiation in the object for example wherein the spatial focusing arrangement comprises a cylindrical focusing element such as a cylindrical lens.

18. (canceled)

19. The system of claim 14, wherein the spatial focusing arrangement comprises a tuneable focusing element such as a tuneable focusing lens for moving the line of incident electromagnetic radiation relative to the object and the scattering medium, for example along the illumination axis.

20. The system of claim 14, wherein the line of incident electromagnetic radiation extends in a direction which is parallel to the illumination axis.

21. The system of claim 20, wherein the spatial focusing arrangement comprises a prism such as a roof-prism located after the spectrally dispersive element for forming the line of incident electromagnetic radiation.

22. The system of claim 11, comprising a translation stage for moving the object and the scattering medium together relative to the incident electromagnetic radiation.

23. The system of claim 11, wherein the illumination arrangement comprises a source of electromagnetic radiation and, optionally, wherein the source of electromagnetic radiation comprises at least one of:
a source of coherent electromagnetic radiation;
a tuneable source of electromagnetic radiation;
a laser;
an optical parametric oscillator (OPO); and
a source of electromagnetic radiation which is configured to generate pulses of electromagnetic radiation such as ultrashort pulses of electromagnetic radiation.

24. The method of claim 1, wherein the object is formed separately from the scattering medium or wherein the object comprises a sub-surface region of a sample and the scattering medium comprises a scattering surface region of the same sample.

25. The method of claim 1, wherein the emitted electromagnetic radiation comprises fluorescence generated by the object as a result of excitation of the object by the incident electromagnetic radiation, and optionally, wherein the incident electromagnetic radiation is configured for multi-photon excitation of the object such as two-photon or three-photon excitation of the object.

26. The system of claim 11, wherein the object is formed separately from the scattering medium or wherein the object comprises a sub-surface region of a sample and the scattering medium comprises a scattering surface region of the same sample.

27. The system of claim 11, wherein the emitted electromagnetic radiation comprises fluorescence generated by the object as a result of excitation of the object by the incident electromagnetic radiation, and optionally, wherein the incident electromagnetic radiation is configures for multi-photon excitation of the object such as two-photon or three-photon excitation of the object.
